(19) United States
(12) Patent Application Publication
(10) Pub. No.: US 2022/0230177 A1
(43) Pub. Date: Jul. 21, 2022

(54) IDENTITY VERIFICATION AND SERVICE PROVISION PLATFORM AND METHOD

(71) Applicant: TreeFort Technologies Incorporated, Edmonton (CA)

(72) Inventors: Jay KRUSHELL, Edmonton (CA); Kim KRUSHELL, Edmonton (CA); William Scott EDGAR, Sherwood Park (CA); Chandra DEVAM, Edmonton (CA)

(73) Assignee: TreeFort Technologies Incorporated, Edmonton, AB (CA)

(21) Appl. No.: 17/628,420

(22) PCT Filed: Jul. 19, 2020
(86) PCT No.: PCT/US20/42697

§ 371 Date: Jan. 19, 2022

Related U.S. Application Data
(60) Provisional application No. 62/876,643, filed on Jul. 20, 2019.

(51) Int. Cl. G06Q 20/40; G06Q 20/38

(52) U.S. Cl. CPC G06Q 20/4014; G06Q 20/3821

(57) ABSTRACT

Disclosed herein are methods and systems for identifying a user's identity. In some embodiments, a method comprises through an electronic device, presenting to the user a user interface enabling the user to select a primary third party and a secondary third party, wherein at least the primary third party has previously authenticated an identity of the user; obtaining, from the user interface, a user input identifying a selected primary third party and a selected secondary third party; through the electronic device, directing the user to a login interface associated with the selected primary third party, wherein the login interface enables the user to provide, directly to a primary third-party system associated with the selected primary third party, at least one preexisting login credential for the primary third-party system; receiving, from the primary third-party system, an indication of whether the primary third-party system recognized the at least one preexisting login credential as valid; receiving a response from a secondary third-party system associated with the selected secondary third party, wherein the response comprises information usable to verify the identity of the user; determining, based on the indication from the primary third-party system and the response from the secondary third-party system, whether the identity of the user has been verified; if it is determined that the identity of the user has been verified, authorizing the user to be provided a service; and if it is determined that the identity of the user has not been verified, preventing the user from being provided the service.

### CROSS-REFERENCE TO RELATED APPLICATIONS

This application claims priority to, and hereby incorporates by reference in its entirety for all purposes, U.S. provisional application No. 62/876,643, filed Jul. 20, 2019 and entitled “IDENTITY VERIFICATION AND SERVICE PROVISION PLATFORM AND METHOD.”

### BACKGROUND

There are a number of settings in which a person's identity must be verified, such as, for example, to obtain a passport or to have a document notarized. In some countries, rules governing attorneys require lawyers to verify the identities of their clients before providing services.

Traditionally, a person who needs his or her identity verified for some reason (the to-be-verified person) must gather documentation (e.g., a birth certificate, passport, driver's license, social security card, bank statement, utility bill, etc.) and appear in person in front of another person (the verifying person) who then inspects the documentation to purportedly verify that the person who has appeared is in fact who he or she purports to be.

There are several problems with the traditional approach to identity verification. A significant disadvantage is the inconvenience of the to-be-verified person having to meet in person with the verifying person. Typically, the to-be-verified person has to leave his or her home or office to attend such a meeting (e.g., to have a document notarized at a bank or a local UPS Store), which is time-consuming, inconvenient, and potentially dangerous. Although it is possible to have the verifying person travel to the location of the to-be-verified person (e.g., a mobile notary), these services tend to be more expensive than when the to-be-verified person travels to the verifying person. Furthermore, the use of such services does not eliminate the need for an in-person meeting for the identity verification process; at least one of the parties still must travel to meet the other, which is time-consuming and increases the overall cost of providing whatever service the to-be-verified person needs. Furthermore, in-person meetings require at least some niceties, such as idle chit-chat and handshakes, which also consume time, may be forced or uncomfortable for some people, and may be risky or dangerous (e.g., during a pandemic).

In addition, often a meeting required for identity verification cannot occur immediately due to the need for one of the parties to travel to the other, and also because finding a time slot that works for both parties can be challenging when both parties have busy schedules. These problems can be exacerbated when more than two people need to meet. Whatever their cause, these delays can have substantial adverse effects, such as missed deadlines and increased service costs.

Another problem with the traditional approach to identity verification is that the documentation on which the verifying person relies can be forged well enough to fool the verifying person. Thus, even with an in-person meeting, it is possible that the verifying person makes a mistake based on forged documentation when the to-be-identified person is not who he or she claims to be.

In addition to situations in which it is imperative to verify a person's identity, there are other situations in which the verification of a person's identity is desirable. For example, in recent years, “bots” have established social media accounts for nefarious purposes, such as to sow discord among people who use social media platforms. Bots are able to establish and use social media accounts because the social media companies do not verify that each account is associated with a real person. In addition to bots, real people sometimes set up social media accounts (or dating profiles) that misrepresent their identities. The purpose of these false accounts may be to harass or tease a real person (e.g., setting up a social media account pretending to be a famous person) or for more nefarious purposes (e.g., in furtherance of illegal activities, such as to facilitate human trafficking or statutory rape).

There are also many settings other than for purposes of identity verification in which people typically must meet in person with one another, such as to have a discussion or to execute a transaction. For example, a person might need to sign a document, such as to purchase a home or obtain a loan. In addition, or alternatively, it may be necessary for a signature to be witnessed, but not necessarily notarized, such as when a testator signs his or her will, in which case an in-person meeting is also typically required.

Regardless of the reason, the need to have a physical proximity meeting for identity verification and to sign documents can be frustrating to people who are increasingly comfortable completing transactions in a digital environment. Furthermore, the need for a physical proximity meeting can be inefficient and limiting. In-person meetings may also be risky, dangerous, and/or contrary to public health orders, such as during a pandemic.

After the verifying person has verified the to-be-verified person's identity, thereby converting the to-be-verified person into a verified person, the two parties may have ongoing interactions via e-mail or other electronic communication. It is possible for a nefarious actor to infiltrate (“hack”) these communications and pose as the verified person in these interactions. The consequences of this type of fraud can be severe. As one example, a nefarious actor might find a way to send e-mail appearing to be from an attorney to a client to request the transfer of funds to an account. The result could be the client thinking he or she is transferring funds to the attorney's trust account, but actually transferring funds to the nefarious actor.

Once a document has been executed with a wet signature, it must be stored and may need to be disseminated. Storage of paper documents can be inconvenient and expensive, particularly if the content of the document is intended to be confidential. Dissemination of an executed confidential document can also present challenges because the transmission method needs to be secure to prevent exposure of the document's contents to unintended audiences. Hardcopy documents can also be manipulated by removing or adding pages, or by changing wording. Moreover, they can be lost altogether.

Document creation is an evolving field. Legal documents may be created from source documents (proprietary or public), which contain the clauses and limitations that a client is looking for, or they may be bespoke. Many documents are created subsequent to and responsive to meetings and discussions between parties, which can require a significant amount of time.

There is an ongoing need for solutions that address the issues and problems described above.

### BRIEF DESCRIPTION OF THE DRAWINGS

Objects, features, and advantages of the disclosure will be readily apparent from the following description of certain embodiments taken in conjunction with the accompanying drawings in which:

FIG. 1 is a flowchart illustrating a method to verify a user's identity in accordance with some embodiments.

FIG. 2A is a timing diagram illustrating various communications in accordance with some embodiments.

FIG. 2B is another timing diagram illustrating various communications in accordance with some embodiments.

FIG. 3 is a block diagram of a platform in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

Disclosed herein are virtual meeting platform systems and methods that provide benefits relative to current approaches and address many of the shortcomings of current approaches. The disclosed systems and methods provide a way to verify a user's identity before a service is provided.

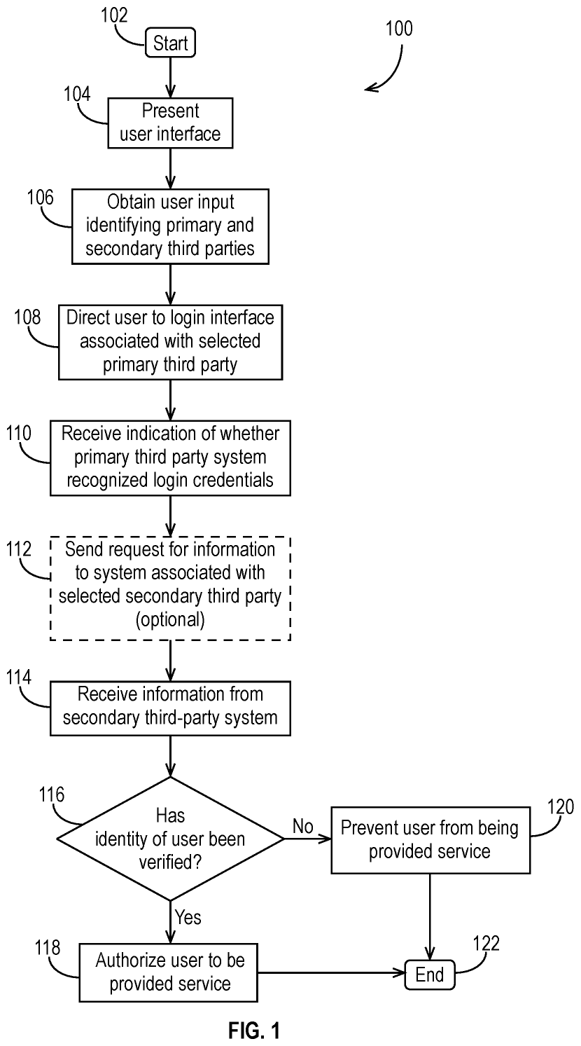

FIG. 1 is a flowchart illustrating a method 100 to verify a user's identity in accordance with some embodiments. In some embodiments, the method 100 is for the purpose of determining whether to authorize the user to be provided a service. In other words, successful completion of the identity verification process is a prerequisite to the user being provided the service. The service may be any suitable service. Examples of services include, but are not limited to, an e-mail account, a social media account, a shopping account, a professional service (e.g., legal, notarial, accounting, etc.), a business service (e.g., creation of a business plan, etc.), a collaborative service (e.g., intra-company communication service), or a government service.

At 102, the method begins. At 104, a user interface is presented to the user through an electronic device (e.g., a computer, a laptop, a smartphone, a tablet, etc.). The user interface enables the user to select a primary third party and a secondary third party. The platform will use information obtained from the primary and secondary third parties to determine whether the user's identity has been verified to a satisfactory degree to allow the service to be provided.

The primary third party is a third party that has previously authenticated the identity of the user. For example, the primary third party may be a third party that has previously met in person with the user, has inspected the user's documentation, and has confirmed the user's identity (such as, for example, in the traditional manner discussed above). Examples of primary third parties may include, but are not limited to, banks, financial services companies, government entities or agencies (e.g., the Social Security Administration, state departments of motor vehicles, etc.), insurance companies, and legal services providers (e.g., an attorney who has previously met in person with the user and has verified his or her identity).

The secondary third party is a third party that maintains data about the user, but has not necessarily previously met with the user or confirmed the user's identity. Examples of secondary third parties include, but are not limited to, utility companies (e.g., electric/gas, water, telephone, etc.), telecommunications companies (e.g., cellular providers, Internet service providers, etc.), waste management companies (e.g., garbage collectors, etc.), credit bureaus (e.g., Equifax, Transunion, Experian), a government agency or entity (e.g., the IRS, a county assessor's office, etc.), professional services firms (e.g., an accountant, attorney, etc.), and healthcare providers (e.g., HMOs, PPOs, doctors' offices, dentists' offices, etc.). The secondary third party may be a third party that also qualifies as a primary third party (i.e., a party that has affirmatively verified the user's identity).

In some embodiments, the user interface presents to the user a list of available primary third parties and a list of available secondary third parties and prompts the user to select at least one primary third party and at least one secondary third party. For example, the user interface may present a list of three candidate primary third parties and two candidate secondary third parties, and prompt the user to select one primary third party and one secondary third party. Alternatively, the user interface may present, for example, a list of a plurality of candidate primary third parties and a plurality of candidate secondary third parties, and give the user the option to select two primary third parties or one primary third party and one secondary third party.

The candidate primary and secondary third parties from which the user can select may be a subset of all available primary and secondary third parties (e.g., the platform may select and present the names of fewer than all available primary third parties and fewer than all available secondary third parties). When the platform presents only a subset of all available candidate primary third parties and/or secondary third parties to the user, the subsets may be randomly selected by the platform, or they may be based on a previous interaction with the user or some other criterion (e.g., an arrangement with the candidate primary/secondary third party). As just one example, if the user previously attempted to use the platform, and his or her identity could not be verified to the necessary extent, the platform may require a higher level of identity authentication when the user attempts to access the platform again (e.g., by requiring the user to select two or more primary third parties, or by presenting only those secondary third parties who meet the criteria to be primary third parties). As another example, if the user previously attempted to use the platform and selected a credit bureau as a secondary third party, and the platform was unable to retrieve credit information (e.g., because the user's credit files are frozen), or the credit bureau did not respond to the platform's request, the platform may elect not to offer any credit bureaus as secondary third parties the next time the user attempts to use the platform.

At 106, the platform obtains, from the electronic device, a user input, which identifies the user's selected primary third party and secondary third party.

At 108, through the electronic device, the platform directs the user to a login interface associated with the selected primary third party. The login interface enables the user to provide at least one preexisting login credential directly to a primary third-party system that is associated with the selected primary third party. The at least one preexisting login credential can be any suitable login credential. To name just a few, the at least one preexisting login credential may comprise any of a username, a password, a code, an image, a question, a response to a question, a fingerprint, biometric data, or a vocal characteristic.

By directing the user to the primary third-party system and allowing the user to provide his or her login credential(s) directly to the primary third-party system, the platform avoids gathering or “touching” the user's login credential(s). Thus, the platform refers the user to the primary third-party system but does not intervene on the user's behalf or participate in the user's interaction with the primary third-party system. Thus, the platform maintains the user's data security by not requiring the user to provide at least one login credential for the primary third-party system to the platform. The user's interaction with the primary third-party system is not visible to the platform.

As an example of a user interaction with the primary third-party system, if the selected primary third party is a bank, the platform directs the user to the bank's website so that the user can interact directly with the bank's website by entering, for example, the user's username and password. The user's interaction with the primary third-party system is independent of and invisible to the platform. The primary third-party system knows (e.g., via a cookie, an HTTP referrer, etc.) only that the login was prompted by the platform, but the platform does not provide any information to the primary third-party system about the reason for the login. In other words, directing the first person to the login interface associated with the selected primary third party does not convey to the selected primary third party a reason that the user will provide the at least one preexisting login credential to the primary third-party system. Thus, the platform maintains the user's privacy by not sending the primary third-party system any information about the reason for the user's access from the platform to the primary third-party system.

The primary third-party system then reports to the platform the result of the user's login attempt. At 110, the platform receives from the primary third-party system an indication of whether the primary third-party system recognized the user-provided at least one preexisting login credential as valid. In some embodiments, the indication is one of two possible responses from the primary third-party system (e.g., “yes” for valid/successful, “no” for invalid/unsuccessful; 1 for valid/successful, 0 for not valid/unsuccessful, etc.) In some embodiments, the indication is not a binary indication (i.e., an indication that takes one of two values). For example, the primary third-party system may return a code (e.g., corresponding to a code from an authentication app on the user's mobile device, etc.), a PIN, or other information (e.g., mother's maiden name, last four digits of the user's social security number, etc.) that only the to-be-verified person would know (or that an imposter would be unlikely to know), and then the platform may require the to-be-verified person to confirm the code, PIN, or other information.

In some embodiments, neither the platform nor the primary third-party system collects or retains the user's personally-identifiable information associated with the platform/primary third-party system interaction.

If the user selected more than one primary third party, steps 108 and 110 are completed for each selected primary third party.

Optionally, at 112, the platform sends a request for information to a secondary third-party system associated with the selected secondary third party. The requested information is usable to verify that the user is who the user purports to be. For example, the requested information may be a binary (e.g., “yes/no” or 1/0) response following a login procedure similar or identical to the one described above for the primary third party. As another example, the platform may request non-binary information directly from the secondary third-party's system (e.g., with the user's permission). As used herein, non-binary information is any information that is other than a “yes/no,” 1/0, or similar representations of two possible values. Examples of non-binary information include credit history information (e.g., from a credit bureau), service address information (e.g., from a utility company), a telephone number (e.g., from a cellular service provider), an amount of a previous bill, a phone number, a copy of a previous bill, a credit report, etc.

At 114, the platform receives a response from the secondary third-party system. The response may follow the optional request at 112 (if present), or it may indicate the result of the user's attempt to log in to the secondary third-party system (e.g., as described above in the context of the primary third-party. The response may be a binary response (e.g., “yes/no” or 1/0) or a non-binary response. In embodiments including optional step 112, the response may include the requested information in whole or in part. For example, if the selected secondary third party is a utility company, the platform may request the name of the party responsible for paying the bill for an address provided by the platform, where the user has provided the address as purportedly being the user's home address. The utility company's system may respond with the requested name (a non-binary response). As another example, the platform may provide a name and address to the utility company system, and the utility company system may respond by confirming whether the provided name and address match the utility company's records (e.g., a “yes/no” binary response).

Alternatively, the response from the secondary third-party system may convey a failure of some kind, such as that the secondary third-party system is unable to provide the requested information for some reason. For example, if the selected secondary third party is a credit bureau, and the user's credit files are frozen or locked, the secondary third-party system may send a response to convey that the request for information was denied. As another example, if the selected secondary third party is a utility company, and the request is to confirm a home address, the utility company's system may respond with an indication that, according to the utility company's records, the name of the party responsible for the bill for the provided home address is not the name contained in the platform's request for information.

In some embodiments, the secondary third-party system does not collect or retain the user's personally-identifiable information associated with the secondary third-party system interaction.

It is to be understood that steps 108, 110, 112 (if performed), and 114 need not be completed in the order shown in FIG. 1. Step 108 takes place before step 110, and step 112 takes place before step 114, but step 108 can occur before or after step 112, and step 110 can occur before or after 114. For example, all of the following sequences are possible (assuming step 112 is performed): 108, 110, 112, 114; 108, 112, 110, 114; 108, 112, 114, 110; 112, 108, 110, 114; 112, 108, 114, 110; 112, 114, 108, 110.

At 116, the platform determines, using the indication from the primary third-party system and the response from the secondary third-party system, whether the identity of the user has been verified. There are myriad ways the platform can make the determination. For example, if the indication from the primary third-party system is positive, and the response from the secondary third-party system provides the requested information, and that information meets the platform's expectation (e.g., it matches information provided by the user, it indicates that the user is sufficiently credit-worthy, etc.), the platform may determine that the user's identity has been verified.

Whether the identity of the user has been verified may be determined using any suitable decision criteria. For example, if the primary and secondary third-party systems each provide a binary response to the platform (e.g., “yes/no” or 1/0), the determination may be made using only hard decision criteria. As an example, a platform using only hard decision criteria may determine that the user's identity has been verified only if both the primary third-party system and the second third-party system provide positive responses; otherwise, the platform may determine that user's identity has not been verified.

Alternatively, the platform may make the determination of whether the identity of the user has been verified using soft criteria or a combination of decision criteria depending on the content of the indication from the primary third-party system and the response from the secondary third-party system. For example, if the primary third-party system provides a binary indication (e.g., “yes/no” or 1/0), and the secondary third-party system provides a value or values (e.g., a current address of the user, or two or more addresses associated with the user's name), the platform may determine that the user's identity has been verified only if the indication from the primary third party system is a positive indication and at least one of the values matches a value provided by the user (e.g., an address provided by the secondary third-party system matches an address provided by the user).

It is to be appreciated that there are many ways the platform can determine whether the user's identity has been verified to a satisfactory degree, which may have objective elements, subjective elements, or both objective and subjective elements. Likewise, the decision may be made using hard criteria, soft criteria, or a combination of hard and soft criteria. The examples given herein are merely illustrative and are not meant to be limiting. Moreover, different criteria may be used for different users.

If, at 116, the platform determines that the user's identity has not been verified, at 120, the platform prevents the user from being provided the service. In some embodiments, in addition to preventing the user from being provided the service, the platform takes an action. For example, the platform may make an entry in a local or remote database to memorialize that the user's identity was not verified. As another example, the platform may file a report with an agency (e.g., law enforcement, a government agency, etc.). As yet another example, the platform may send a report to the selected primary third party, another primary third party, the selected secondary third party, and/or another secondary third party.

In some embodiments, the action is to change some aspect of the method 100 performed if the user later attempts to access the platform again. For example, the platform may make more stringent the criteria for determining that the user's identity has been verified. As an example, the platform may require the user to select more than one primary third party and/or more than one secondary third party after a user's identity was unable to be verified during a previous attempt.

As another example, the platform may change the determination criteria to be performed in step 116. For example, if, when the user first accesses the platform, the platform requires a positive indication from the primary third-party system and a response meeting or exceeding a particular value from the secondary third-party system (e.g., a minimum credit score requirement), the platform may change the particular value for a second or subsequent attempt by the user to access the service via the platform (e.g., raising the minimum credit score requirement).

If, at 116, the platform determines that the user's identity has been verified, at 118, the platform authorizes the user to be provided the service. In some embodiments, authorizing the user to be provided the service comprises the platform prompting the user to establish a user account. Establishing a user account may include the platform capturing biometric information from the user. The biometric information may include, for example, a retinal scan, a vocal characteristic, a fingerprint, a physical feature, etc. In some embodiments, capturing biometric information comprises making a voice recording of the user or taking at least one image of a physical feature (e.g., a face, retina, fingerprint, etc.) of the user. In some embodiments in which establishing the user account includes capturing biometric information from the user, the method 100 further comprises establishing the user account, associating the user account with the captured biometric information, and prompting the user to provide the biometric information to log in to the user account.

In some embodiments, the method 100 further comprises prompting the user to log in to the user account, establishing a secure virtual meeting environment, and authorizing the user to participate in the secure virtual meeting environment after successfully logging into the user account. In some embodiments, authorizing the user to participate in the secure virtual meeting environment is further based on a validation of one or more of: an IP address, a characteristic of a connection to the secure virtual meeting environment, security data, biometric data associated with the user, or metadata.

At 122, the method 100 ends.

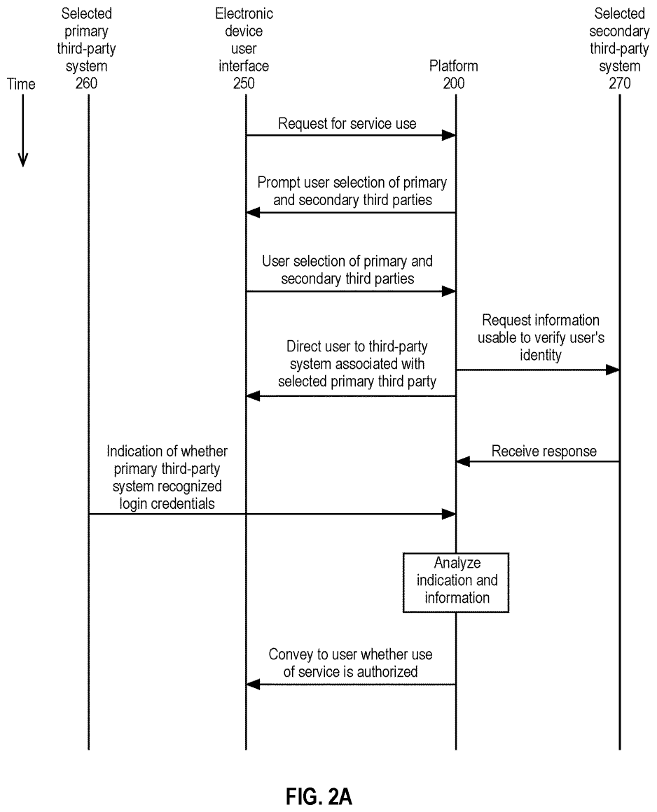

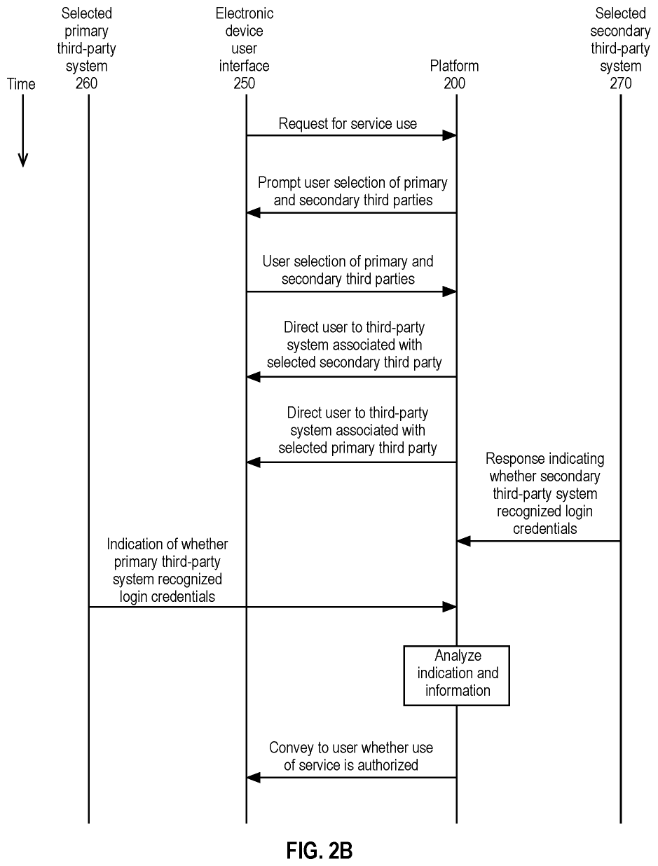

FIG. 2A is a timing diagram illustrating various communications in accordance with an embodiment of the method 100 that includes the optional step 112. FIG. 2A begins with the platform 200 receiving a user request for the use of a service. The platform 200 then prompts the user to select primary and secondary third parties via the electronic device user interface 250 (step 104 of the method 100). The user then selects the primary and secondary third parties. The platform 200 sends, to a system 270 associated with the selected secondary third-party, a request for information usable to verify the user's identity (step 112 of the method 100). Before or after that, the platform 200 directs the user to a third-party system 260 associated with the selected primary third party (step 108 of the method 100). The platform 200 receives a response from the secondary third-party system 270 (step 114 of the method 100) and, from the primary third-party system 260, an indication of whether the primary third-party system recognized the at least one login credential. After analyzing the response and the indication, the platform 200 conveys to the user whether the use of the requested service is authorized (result of step 116 of the method 100).

FIG. 2B is a timing diagram illustrating various communications in accordance with another embodiment of the method 100 that does not include the optional step 112. FIG. 2B begins with the platform 200 receiving a user request for the use of a service. The platform 200 then prompts the user to select primary and secondary third parties via the electronic device user interface 250 (step 104 of the method 100). The user then selects the primary and secondary third parties. In this embodiment, the platform 200 obtains only binary information from both the primary and secondary third-party systems. The platform 200 directs the user to a third-party system 260 associated with the selected secondary third party (step 108 of the method 100). Before or after that, the platform 200 directs the user to a third-party system 260 associated with the selected primary third party (step 108 of the method 100). The platform 200 receives a response from the secondary third-party system 270 (step 114 of the method 100; note that optional step 112 is not performed in this example) and, from the primary third-party system 260, an indication of whether the primary third-party system recognized the at least one login credential. After analyzing the response and the indication, the platform 200 conveys to the user whether the use of the requested service is authorized (result of step 116 of the method 100).

It is to be understood that the timing diagrams of FIG. 2A and FIG. 2B are exemplary and are not intended to be limiting. For example, as previously explained, the user may be required to select more than one primary third party and/or more than one secondary third party. Similarly, one or more secondary third parties may qualify as a primary third party. Furthermore, some of the communications need not take place in the order illustrated, as explained above.

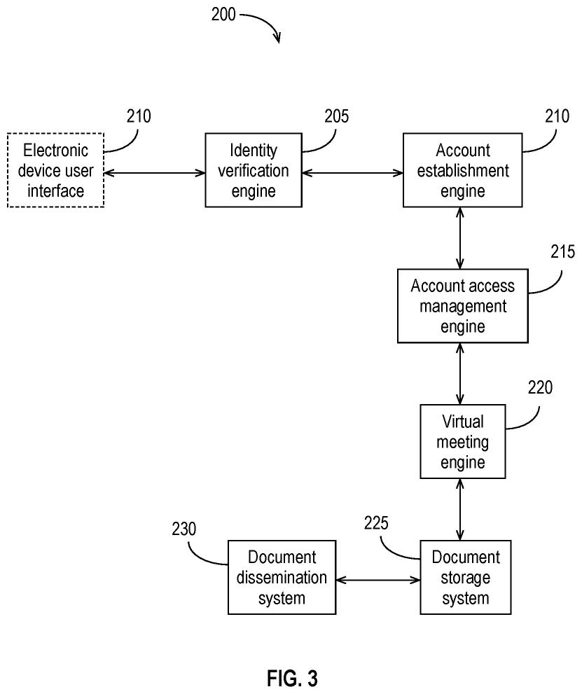

FIG. 3 is a block diagram of a platform 200 in accordance with some embodiments. The platform 200 comprises an identity verification engine 205. The identify verification engine 205 may be configured to perform some or all of the method 100 described above. For example, the identity verification engine 205 may be configured to perform the method 100 illustrated in FIG. 1, with or without optional step 112. As shown in FIG. 3, the identity verification engine 205 is in communication with an electronic device user interface 210. The electronic device user interface 210 is shown having a dashed line because it may be a part of the platform 200, or it may be external to the platform 200 (e.g., a user interface of a device belonging to the user, such as a mobile device, a computer, etc.).

As shown in FIG. 3, the identity verification engine 205 is also in communication with an account establishment engine 210, which may perform the steps associated with establishing the user account after the identity of the user has been verified in step 116 of the method 100. As explained above, establishing the user account may include the platform capturing biometric information (e.g., a retinal scan, a vocal characteristic, a fingerprint, a physical feature, a voice recording, an image of a physical feature, etc.) and associating the user account with the captured biometric information.

The platform 200 also includes an account access management engine 215. The account access management engine 215 manages the user's access to his or her account (e.g., to enable the user to log in). For example, if the account establishment engine 210 collected biometric information to establish the user's account, the account access management engine 215 may prompt the user to provide the biometric information to log in to the user account.

As shown in FIG. 3, the platform 200 also includes a virtual meeting engine 220. The virtual meeting engine 220 operates to establish a secure virtual meeting environment and authorize the user to participate in the secure virtual meeting environment after successfully logging into the user account. The virtual meeting engine 220 may authorize the user to participate in the secure virtual meeting environment after validating an IP address, a characteristic of a connection to the secure virtual meeting environment, security data, biometric data associated with the user, or metadata.

After establishing a virtual meeting environment, the platform 200 may make a document available in the secure virtual meeting environment. In the secure virtual meeting environment, the document may be available to and visible to the user and a witness (e.g., an attorney, a notary, a business partner, an uninterested third party, etc.). The platform 200 may be operable to capture the user's signature on the document in the secure virtual meeting environment and in view of at least the witness. For example, the document may be a document requiring notarization, and the witness may be a notary.

There are many ways the platform may capture the user's signature. For example, the platform 200 may bind an electronic signature or a digitally encrypted signature to the document. The user and/or witness may use an immersive technology (e.g., virtual reality, augmented reality, video messaging, etc.) to see the user's signature being captured on the document.

After capturing the user's signature, the platform 200 may disseminate the signed document to the user and/or the witness and/or other parties (e.g., a bank, a government agency, etc.). Referring again to FIG. 3, the platform 200 may include a document dissemination system 230 that is operable to disseminate the signed document as described. The document dissemination system 230 may be operable to add identifying information to the signed document, such as a tag (e.g., a barcode, a QR code, a machine-readable identifying mark, a fingerprint, an image, metadata, etc.). If the tag is a fingerprint or other biometric data associated with the user, it may be captured from the user within the secure virtual meeting environment or during the process to establish the user account (if that process includes the capture of biometric data).

After capturing the user's signature, the platform 200 may store the signed document, such as, for example, using a list of records (e.g., a blockchain) that are linked using cryptography. For example, each record in the list of records may contain a cryptographic hash of a previous record, a timestamp, and/or transaction data. Blockchain is a technology that uses a distributed network to store and ratify data, wherein the majority rules with respect to the truth of data. This also allows both redundancy and security as a corrupted or missing block can be replaced by the remainder of the system. A novel addition to blockchain offering further security of assets is allowing the asset being identified overriding access over their own block or blocks. The security of blockchain is based on ratification of blocks over a distributed network, with the majority being the prevailing truth. This exception to the majority rule enables asset security by protecting the blockchain from attacks. Thus, the platform 200 may be operable to overwrite a record in the list of records.

As shown in FIG. 3, the platform 200 may include a document storage system 225 operable to store documents, such as the signed document or a draft document to be signed in the secure virtual meeting environment.

It is to be appreciated that there may be situations in which there is no need for a participant in the secure virtual meeting environment to sign the document. As one example, attorneys in a law firm who are remote from each other may use the virtual meeting platform 200 to create a document that a party not participating in the virtual meeting may later sign.

As disclosed herein, a virtual meeting platform 200 may include some or all of the following features: video conferencing that allows multiple parties to participate in a meeting and allow each participant to see all of the other participants; multiple identity verification features that can be used to identify all individuals who are participating in the meeting with a high degree of certainty; an electronic signature feature that utilizes one or both of electronic signatures and digitally encrypted signatures that are bound to the document(s) that enable participants in the meeting to visually observe the documents being signed; document storage that uses a distributed network to store and ratify data; multilayered security that ensures only the parties who have been invited to the meeting have access to the virtual meeting space and the documents signed during the meeting.

By using a virtual meeting platform 200 with these features, lawyers can interact with their clients, whether they have previously met these client(s) in person or not, virtually and without the requirement for a physical proximity meeting. The platform can also be used by other professionals, governments, businesses and members of the general public, to conduct meetings and execute documents. The platform can be used for electronic voting and other such applications in which verification of a person's identity prior to a transaction is desirable or necessary.

An example application illustrates of how the platform 200 facilitates identity verification and, for some applications, secure virtual meetings in accordance with some embodiments. Assume Person has decided she needs a will. She contacts an attorney, and Attorney agrees to assist Person. Attorney informs Person that she will interact with Attorney in the platform 200 to maintain privacy and confidentiality and also so that Person has the option of signing the will, with a witness present, without having to appear in person at Attorney's office. Attorney informs Person that Person will need to set up an account in the platform 200 to begin the process.

Person enters the platform 200 and selects, for example, one primary third party and one secondary third party. Assume that Person selects her bank as the primary third party and a utility company as the secondary third party. The platform 200 directs Person to the bank's website, and Person is prompted to log in. The bank's system knows only that the login attempt originated from the platform 200, but not why. Thus, the bank's system (and, consequently, the bank itself) does not receive any information that would convey or from which the bank could conclude that the purpose of the login attempt is so that Attorney can provide the estate planning service (i.e., drafting a will) to Person. The bank's system then sends to the platform 200 an indication of whether Person's login attempt was successful (e.g., a “1” if successful, and a “0” if unsuccessful).

The platform 200 also interacts with the utility company's system. For example, when step 112 is performed, the platform 200 might send a request for and obtain a copy of Person's most recent utility bill.

The platform 200 then analyzes the utility bill and the indication from the bank. Assuming that the information in the utility bill is as expected, and the bank's system indicates that the login attempt was successful, the platform 200 determines that Person's identity has been verified. The platform 200 then prompts Person to set up an account in the platform 200 so that she does not have to repeat the identity verification process again in the future.

Attorney is then notified (either by Person or by the platform 200) that Person's identity has been verified and that Person has established an account on the platform 200. Attorney can then interact with Person in the platform 200 to complete the will. For example, Attorney and Person can have video and text conversations within a secure virtual meeting environment established by and through the platform 200. The platform 200 facilitates the exchange and storage of the will both as it is being drafted and after it has been completed. When the will is ready for Person's signature, a witness can be invited to the secure virtual meeting environment to witness Person signing the will.

Having had her identity verified by the platform 200, Person can later consume other services for which identity verification is desirable or necessary without having to repeat the identity verification procedure. For example, a social media company that requires identity verification prior to allowing an account to be established can rely on the platform 200's prior verification of Person's identity (e.g., by accessing Person's profile in the platform 200, or by Person initiating the account setup request from within the platform 200).

It is to be understood that FIG. 3 is a conceptual block diagram, and various of the illustrated blocks may be combined in an implementation. For example, some or all of the identity verification engine 205, account establishment engine 210, account access management engine 215, virtual meeting engine 220, document storage system 225, and/or document dissemination system 230 can be combined into a single engine, which may be implemented, for example, in a programmable computer. Conversely, the various engines and systems can be split into smaller units (e.g., subroutines, programs, etc.) in an implementation.

The various engines and systems described herein (i.e., the identity verification engine 205, account establishment engine 210, account access management engine 215, virtual meeting engine 220, document storage system 225, and/or document dissemination system 230) may be implemented using one or more processors. For example, the platform 200 may include at least one programmable central processing unit (CPU), which may be implemented by any known technology, such as a microprocessor, microcontroller, application-specific integrated circuit (ASIC), digital signal processor (DSP), or the like. The CPU may be integrated into an electrical circuit, such as a conventional circuit board, that supplies power to the CPU. The CPU may include internal memory and/or external memory may be coupled thereto. The memory may be coupled to the CPU by a suitable internal bus.

The memory may comprise random access memory (RAM), read-only memory (ROM), or other types of memory. The memory contains instructions and data that control the operation of the CPU. The memory may also include a basic input/output system (BIOS), which contains the basic routines that help transfer information between elements within the platform 200. The platform 200 is not limited by the specific hardware component(s) used to implement the CPU or memory components of the platform 200.

Optionally, the memory may include external or removable memory devices such as floppy disk drives and optical storage devices (e.g., CD-ROM, R/W CD-ROM, DVD, and the like). The platform 200 may also include one or more I/O interfaces, such as a serial interface (e.g., RS-232, RS-432, and the like), an IEEE-488 interface, a universal serial bus (USB) interface, a parallel interface, and the like, for the communication with removable memory devices such as flash memory drives, external floppy disk drives, and the like.

The memory may record some or all interactions with users (e.g., video, audio, user inputs, etc.).

The electronic device user interface 210 may include any suitable user interface(s). For example, the electronic device user interface 210 may include graphic user interface such as a standard computer monitor, LCD, or other visual display. The electronic device user interface 210 may also include an audio system capable of detecting and/or playing an audible signal. The electronic device user interface 210 may also include a video or imaging system capable of capturing video and/or images. The electronic device user interface 210 may permit the user to enter responses or commands into the platform 200 (e.g., a microphone, camera, keyboard, etc.). For example, the user may respond to a query from the platform 200. The user electronic device user interface 210 may include a standard keyboard, mouse, track ball, buttons, touch sensitive screen, wireless user input device and the like. The electronic device user interface 210 may be coupled to the CPU by a suitable internal bus.

The platform 200 may be in communication with at least one remote platform for accessing the platform 200 through a network (e.g., the Internet or other wired or wireless network). The remote platform may be any suitable computer operative to access the platform 200. Such computers include desktop computers, laptop computers, mobile phones, tablet computers, and the like. The remote platform may include a graphical user interface such as a standard computer monitor, LCD, or other visual display. The user interface may also include an audio system capable of playing an audible signal. The user interface may be a virtual reality (VR) headset or any type of head-mounted display. The user interface may be a VR display, an augmented reality (AR) display, or the like. The user interface may be a pair of smart glasses (e.g., an optical head-mounted display in the shape of a pair of eyeglasses, such as, e.g., Google glass). The user interface may permit the user to enter responses or commands into the platform for interaction with the platform 200 through the network connection.

The user interface may include a standard keyboard, mouse, track ball, buttons, touch sensitive screen, wireless user input device and the like. The user interface may be coupled to the CPU by an internal bus. The remote platform may also include memory coupled to the CPU by an internal bus. The memory may comprise random access memory (RAM) and read-only memory (ROM). The memory may also include a basic input/output system (BIOS), which contains the basic routines that help transfer information between elements within the remote platform. The platform 200 is not limited by the specific hardware component(s) used to implement the CPU or memory components of the remote platform (if present).

The platform 200 may also be in communication with one or more external databases. The various components of the platform 200 may be coupled together by internal buses. Each of the internal buses may be constructed using a data bus, control bus, power bus, I/O bus, and the like. The platform may include instructions executable by the CPU for operating the platform 200 described herein. These instructions may include computer-readable software components or modules stored in the memory, or stored and executed on one or more other computers of the platform.

In the foregoing description and in the accompanying drawings, specific terminology has been set forth to provide a thorough understanding of the disclosed embodiments. In some instances, the terminology or drawings may imply specific details that are not required to practice the invention.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.” The terms “exemplary” and “embodiment” are used to express examples, not preferences or requirements.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A method for verifying a user's identity, the method comprising:
through an electronic device, presenting to the user a user interface enabling the user to select a primary third party and a secondary third party, wherein at least the primary third party has previously authenticated an identity of the user;
obtaining, from the user interface, a user input identifying a selected primary third party and a selected secondary third party;
through the electronic device, directing the user to a login interface associated with the selected primary third party, wherein the login interface enables the user to provide, directly to a primary third-party system associated with the selected primary third party, at least one preexisting login credential for the primary third-party system;
receiving, from the primary third-party system, an indication of whether the primary third-party system recognized the at least one preexisting login credential as valid;
receiving a response from a secondary third-party system associated with the selected secondary third party, wherein the response comprises information usable to verify the identity of the user; and
determining, based on the indication from the primary third-party system and the response from the secondary third-party system, whether the identity of the user has been verified.

2. The method of claim 1, further comprising sending, to the secondary third-party system a request for the information usable to verify the identity of the user, and wherein the response comprises non-binary information.

3. The method of claim 2, wherein the non-binary information comprises a name, an address, a phone number, an account number, a copy of a bill, a billed amount, or a credit score.

4. The method of claim 1, wherein the login interface is a first login interface and the preexisting login credential is a first pre-existing login credential, and further comprising:
through the electronic device, directing the user to a second login interface associated with the selected secondary third party, wherein the second login interface enables the user to provide, directly to the secondary third-party system, at least one second preexisting login credential for the secondary third-party system,
and wherein the response indicates whether the secondary third-party system recognized the at least one second preexisting login credential as valid.

5. The method of claim 4, wherein directing the user to the second login interface associated with the selected secondary third party does not convey to the selected secondary third party a reason for the user to provide, directly to the selected secondary third-party system, the at least one second preexisting login credential for the secondary third-party system.

6. The method of claim 1, further comprising, in response to determining that the identity of the user has not been verified, making an entry in a database, filing a report with an agency, sending a report to the selected primary third party, sending the report to the selected secondary third party, sending the report to another primary third party, and/or sending the report to another secondary third party.

7. (canceled)

8. The method of claim 1, wherein enabling the user to select a primary third party and a secondary third party comprises enabling the user to select the primary third party from a plurality of candidate primary third parties or select the secondary third party from a plurality of candidate secondary third parties.

9. The method of claim 8, wherein the plurality of candidate primary third parties is a subset of available primary third parties, and/or the plurality of candidate secondary third parties is a subset of available secondary third parties.

10. (canceled)

11. The method of claim 1, wherein the selected primary third party is a bank, a financial services company, a government entity, an insurance company, a legal services provider, or a government agency.

12. The method of claim 1, wherein the selected secondary third party is a utility company, a telecommunications company, a waste management company, a credit bureau, a credit reporting agency, a government entity, a government agency, a professional services firm, or a healthcare provider.

13-17. (canceled)

18. The method of claim 1, wherein the indication of whether the primary third-party system recognized the at least one preexisting login credential as valid is one of two possible responses from the primary third-party system.

19. The method of claim 1, wherein the indication of whether the primary third-party system recognized the at least one preexisting login credential as valid does not include collection or retention of personally-identifiable information.

20. The method of claim 1, wherein directing the user to the login interface associated with the selected primary third party does not convey to the selected primary third party a reason for the user to provide, directly to the selected primary third-party system, the at least one preexisting login credential for the primary third-party system associated with the selected primary third party.

21. The method of claim 1, wherein the selected primary third party is a first selected primary third party, the primary third-party system is a first primary third-party system, the at least one preexisting login credential is a first at least one preexisting login credential, the login interface is a first login interface, the indication is a first indication, and the user input further identifies a second selected primary third party, and further comprising:
through the electronic device, directing the user to a second login interface associated with the second selected primary third party, wherein the second login interface enables the user to provide, directly to the second selected primary third party, a second at least one preexisting login credential for a second primary third-party system associated with the second selected primary third party; and
receiving, from the second primary third-party system, a second indication of whether the second primary third-party system recognized the second at least preexisting login credential as valid,
and wherein determining whether the identity of the user has been verified is further based on the second indication from the second primary third-party system.

22. The method of claim 1, wherein the selected secondary third party is a first selected secondary third party, the secondary third-party system is a first secondary third-party system, the information is first information, the response is a first response, and the user input further identifies a second selected secondary third party, and further comprising:
sending, to a second secondary third-party system associated with the second selected secondary third party, a request for second information usable to verify the identity of the user; and
receiving a second response from the second secondary third-party system,
and wherein determining whether the identity of the user has been verified is further based on the second response from the second secondary third-party system.

23. The method of claim 1, further comprising, in response to determining that the identity of the user has been verified:
prompting the user to establish a user account; and
establishing the user account.

24-29. (canceled)

30. The method of claim 23, further comprising:
establishing a secure virtual meeting environment; and
authorizing the user to participate in the secure virtual meeting environment based at least in part on a successful log in to the user account.

31. (canceled)

32. The method of claim 30, further comprising:
making available, in the secure virtual meeting environment, a document, the document being visible to the user and a witness; and
capturing, in the secure virtual meeting environment, in view of at least the witness, a signature of the user on the document.

33-46. (canceled)

47. The method of claim 32, further comprising adding a tag to the document, wherein the tag comprises a barcode, a OR code, a machine-readable identifying mark, a document fingerprint, an image, or metadata.

48-55. (canceled)

56. The method of claim 30, further comprising:
detecting a presence of an unauthorized person in a vicinity of the user; and
in response to the detecting, terminating the secure virtual meeting environment.
